(19) United States
(12) Patent Application Publication
(10) Pub. No.: US 2013/0332112 A1
(43) Pub. Date: Dec. 12, 2013

(54) STATE ESTIMATION DEVICE

(71) Applicant: Hiroshi Nakamura, Isehara-shi (JP)

(72) Inventor: Hiroshi Nakamura, Isehara-shi (JP)

(73) Assignee: TOYOTA JIDOSHA KABUSHIKI KAISHA, Toyota-shi, Aichi (JP)

(21) Appl. No.: 14/000,487

(22) PCT Filed: Mar. 1, 2011
(86) PCT No.: PCT/JP2011/054651

§ 371 Date: Aug. 20, 2013

(51) Int. Cl. G06F 17/18

(52) U.S. Cl. CPC G06F 17/18
USPC 702/181

(57) ABSTRACT

Disclosed is a state estimation device capable of estimating the state of an observation target with high accuracy. A state estimation device performs Kalman filter update processing for applying measured data of a target vehicle by a LIDAR to a state estimation model so as to estimate the state of a vehicle near the host vehicle. The state estimation device changes the state estimation model for use in the Kalman filter update processing on the basis of the positional relationship with the target vehicle or the state of the target vehicle.

### TECHNICAL FIELD

The present invention relates to an estimation device which applies measured data to a state estimation model so as to estimate the state of an observation target.

### BACKGROUND ART

Heretofore, as a technique for estimating the state of a dynamic observation target, a device described in Japanese Unexamined Patent Application Publication No. 2002-259966 is known. The device described in Japanese Unexamined Patent Application Publication No. 2002-259966 includes a plurality of recognition means, and switches recognition methods according to predetermined conditions, thereby achieving high-accuracy estimation.

### CITATION LIST

### Patent Literature

[Patent Literature 1] Japanese Unexamined Patent Application Publication No. 2002-259966

### SUMMARY OF INVENTION

### Technical Problem

However, even in the technique described in Japanese Unexamined Patent Application Publication No. 2002-259966, since it is not possible to obtain sufficient estimation accuracy, there is a demand for a higher-accuracy estimation method.

Accordingly, in recent years, a state estimation method using a filter, such as a Kalman filter, has been introduced. In the Kalman filter, first, a state estimation model, such as an observation model, an observation noise model, a motion model, or a motion noise model, is set. Then, in the Kalman filter, measured data of an observation target is applied to the set state estimation model so as to estimate the state of a dynamic observation target with high accuracy.

However, in the state estimation method using the Kalman filter in the related art, although the state of the observation target changes every moment, since the state estimation model is fixed, there is a problem in that it is not always possible to estimate the state of the observation target with high accuracy.

Accordingly, an object of the invention is to provide a state estimation device capable of estimating the state of an observation target with higher accuracy.

### Solution to Problem

The invention provides a state estimation device which applies measured data measured by a measurement device measuring an observation target to a state estimation model so as to estimate the state of the observation target, the state estimation device having changing means for changing the state estimation model on the basis of the positional relationship with the observation target or the state of the observation target.

With the state estimation device according to the invention, since the state estimation model changes on the basis of the positional relationship with the observation target or the state of the observation target, it is possible to estimate the state of a dynamic observation target with higher accuracy.

In this case, it is preferable that the observation target is a vehicle near the measurement device, and the changing means changes the state estimation model on the basis of the direction of the center position of the observation target with respect to the measurement device. If the direction of the center position of the observation target with respect to the measurement device differs, the measurable surface of the observation target differs. For this reason, if the same state estimation model is used regardless of the direction of the center position of the observation target with respect to the measurement device, it is not possible to appropriately associate measured data with the state estimation model. As a result, it is not possible to estimate the state of the observation target with high accuracy. Accordingly, the state estimation model is changed on the basis of the direction of the center position of the observation target with respect to the measurement device so as to appropriately associate measured data with the state estimation model. Therefore, it is possible to further improve estimation accuracy of the state of the observation target.

It is preferable that the observation target is a vehicle near the measurement device, and the changing means changes the state estimation model on the basis of the orientation of the observation target. If the orientation of the observation target differs, the measurable surface of the observation target differs. For this reason, if the same state estimation model is used regardless of the orientation of the observation target, it is not possible to appropriately associate measured data with the state estimation model. As a result, it is not possible to estimate the state of the observation target with high accuracy. Accordingly, the state estimation model is changed on the basis of the orientation of the observation target so as to appropriately associate measured data with the state estimation model, thereby further improving estimation accuracy of the state of the observation target.

It is preferable that the observation target is a vehicle near the measurement device, and the changing means changes the state estimation model on the basis of both the direction of the center position of the observation target with respect to the measurement device and the orientation of the observation target. The surface of the observation target facing a host vehicle can be specified by both the direction of the center position of the observation target with respect to the measurement device and the orientation of the observation target. For this reason, the state estimation model is changed on the basis of both kinds of information so as to appropriately associate measured data with the state estimation model, thereby further improving estimation accuracy of the observation target.

It is preferable that the changing means narrows a state estimation model down, to which measured data is applied, on the basis of a state estimation model used in a previous estimation. Usually, since change in the behavior of the observation target is continuous, the state estimation models are narrowed down on the basis of the state estimation model used in the previous estimation, thereby reducing erroneous selection of a state estimation model.

It is preferable that the changing means estimates the direction of the center position of the observation target with respect to the measurement device or the orientation of the observation target on the basis of the previously estimated state of the observation target. In this way, previously estimated information is used, and thus continuity of estimation is secured, thereby further improving estimation accuracy of the state of the observation target.

It is preferable that the changing means estimates the orientation of the observation target on the basis of map information of a position where the observation target is present. When the observation target is stationary, immediately after the observation target is detected, or the like, it is not possible to obtain the orientation of the observation target by measured data. Accordingly, with the use of map information of the position where the observation target is present, even in the above case, it is possible to estimate the orientation of the observation target.

It is preferable that the changing means generates a model of the observation target from measured data and changes the state estimation model on the basis of the number of sides constituting the model. In this way, the state estimation model is changed on the basis of the number of sides of the model generated from measured data, and thus the change criterion of the state estimation model is clarified, thereby further improving estimation accuracy of the state of the observation target.

It is preferable that the state estimation model includes an observation noise model which represents observation noise due to a measurement of the measurement device as a variance value, and the changing means changes the variance value of the observation noise model on the basis of the orientation with respect to the surface of the observation target. Usually, observation noise of measured data is small in the direction perpendicular to the surface of the observation target, and observation noise of measured data is large in the direction parallel to the surface of the observation target. Accordingly, the variance value of the observation noise model is changed on the basis of the orientation with respect to the surface of the measurement target, thereby further improving estimation accuracy of the state of the observation target.

It is preferable that the changing means changes the observation noise model on the basis of the distance to the observation target. If it is close to the observation target, since the region to be measured of the observation target is large, observation noise decreases. If it is far from the observation target, since the region to be measured of the observation target is small, observation noise increases. Accordingly, the observation noise model is changed depending on the distance to the measurement target, thereby further improving estimation accuracy of the state of the observation target.

It is preferable that the observation target is a vehicle near the measurement device, the state estimation model includes a motion model which represents the motional state of the near vehicle, and a motion noise model which represents the amount of change in a steering angle in the motion model, and if the speed of the observation target is high, the changing means decreases the amount of change in the steering angle in the motion noise model compared to when the speed of the observation target is low. Usually, if the speed of the vehicle is high, the steering is not likely to be swung largely. Accordingly, if the speed of the observation target is high, the amount of change in the steering angle in the motion noise model decreases, thereby further improving estimation accuracy of the state of the observation target.

It is preferable that the state of the observation target is estimated using a plurality of different state estimation models, estimated variance values of the state of the observation target are calculated, and the state of the observation target with the smallest estimated variance value is output. Accordingly, even when the positional relationship with the observation target or the state of the observation target is not clear, it is possible to output the state of the observation target using an appropriate state estimation model.

### Advantageous Effects of Invention

According to the invention, it is possible to estimate the state of the observation target with high accuracy.

### BRIEF DESCRIPTION OF DRAWINGS

FIG. 1 is a block diagram showing a state estimation device according to this embodiment.

FIG. 2 is a diagram showing variables to estimate.

FIG. 3 is a diagram showing estimation processing of a state estimation device according to a first embodiment.

FIG. 4 is a diagram showing an azimuth angle of a barycentric position and a speed orientation of the barycentric position.

FIG. 5 is a diagram showing a change criterion example of an observation model.

FIG. 6 is a diagram illustrating a right oblique rear observation model.

FIG. 7 is a diagram illustrating a rear observation model.

FIG. 8 is a diagram showing estimation processing of a state estimation device according to a second embodiment.

FIG. 9 is a diagram showing estimation processing of a state estimation device according to a third embodiment.

FIG. 10 is a diagram showing estimation processing of a state estimation device according to a fourth embodiment.

FIG. 11 is a diagram showing estimation processing of a state estimation device according to a fifth embodiment.

FIG. 12 is a diagram showing model selection processing of FIG. 11.

FIG. 13 is a diagram showing estimation processing of a state estimation device according to a sixth embodiment.

FIG. 14 is a diagram showing the relationship between a target vehicle and grouping point group data.

FIG. 15 is a diagram showing the concept of an observation noise model.

FIG. 16 is a diagram showing estimation processing of a state estimation device according to a seventh embodiment.

FIG. 17 is a diagram showing estimation processing of a state estimation device according to an eighth embodiment.

FIG. 18 is a diagram showing estimation processing of a state estimation device according to a ninth embodiment.

### DESCRIPTION OF EMBODIMENTS

Hereinafter, a preferred embodiment of a state estimation device according to the invention will be described in detail referring to the drawings. In all drawings, it is assumed that the same or equivalent portions are represented by the same reference numerals.

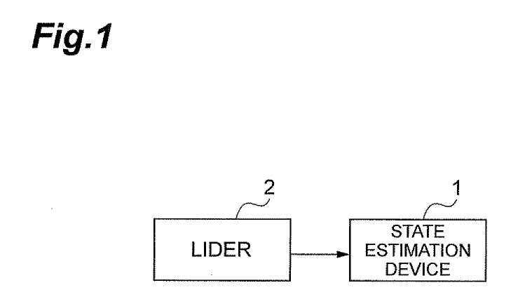

FIG. 1 is a block diagram showing a state estimation device according to this embodiment. A state estimation device 1 according to this embodiment is mounted in a vehicle, and is electrically connected to a light detection and ranging (LIDAR) 2.

The LIDAR 2 is a radar which measures the other vehicle using laser light, and functions as a measurement device. The LIDAR 2 emits laser light, and receives reflected light of the emitted laser light so as to detect a point sequence of reflection points. The LIDAR 2 calculates measured data of the detected point sequence from the speed of laser light, the emission time of laser light, and the reception time of reflected light. For example, measured data includes the relative distance to a host vehicle, the relative direction with respect to the host vehicle, the coordinates calculated from the relative distance to the host vehicle and the relative direction with respect to the host vehicle, and the like. The LIDAR 2 transmits measured data of the detected point sequence to the state estimation device 1.

The state estimation device 1 estimates the state of the other vehicle near the host vehicle by estimation processing using a Kalman filter.

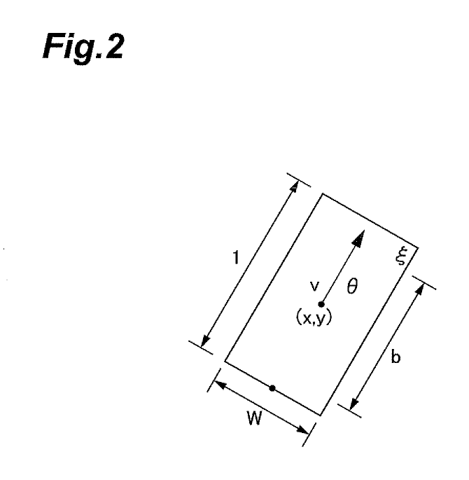

Specifically, the state estimation device 1 first sets the other vehicle near the host vehicle as a target vehicle to be observed, and sets the state of the target vehicle as a variable to estimate. FIG. 2 is a diagram showing variables to estimate. As shown in FIG. 2, for example, variables to estimate are center position (x), center position (y), speed (v), orientation (θ), tire angle (ζ), wheel base (b), length (l), and width (w).

The state estimation device 1 applies measured data transmitted from the LIDAR 2 to a predetermined state estimation model so as to estimate the respective variables, and outputs the estimated variables as the state estimation values of the target vehicle. In this embodiment, processing for estimating is referred to as Kalman filter update processing.

The state estimation device 1 changes the state estimation model for use in the Kalman filter update processing on the basis of the positional relationship with the target vehicle or the state of the target vehicle. For this reason, the state estimation device 1 also functions as changing means for changing the state estimation model. As described below, the state estimation model for use in the Kalman filter update processing is represented by an observation model, an observation noise model, a motion model, and a motion noise model.

Here, the concept of the Kalman filter will be simply described. The Kalman filter itself is a known technique, and thus detailed description will be omitted.

The Kalman filter estimates the state (state vector) xₖ of the observation target when only an observation amount (observation vector) zₖ is observed. For this reason, xₖ is a variable to obtain by estimation. In this embodiment, measured data measured by the LIDAR 2 corresponds to the observation amount.

The observation amount zₖ at the time k is expressed by an observation model shown in Expression (1).

[Equation 1]

zₖ=Hxₖ+vₖ (1)

Here, vₖ is an observation noise model which represents observation noise entering an observation model. For example, observation noise is an error caused by the characteristic of the LIDAR 2, or an error caused by observation, such as a read error of the LIDAR 2. The observation noise model vₖ is expressed by Expression (2) or Expression (3) in accordance with a normal distribution of mean 0 and variance R.

[Equation 2]

pᵥ_{ₖ}(v)˜exp{−v^{T}R⁻¹v} (2)

E(vₖ vₖ^{T})=R (3)

The state xₖ at the time k is represented by a motion model shown in Expression (4).

[Equation 3]

xₖ=Axₖ₋₁+Buₖ₋₁+wₖ₋₁ (4)

Here, uₖ is an operation amount. wₖ is a motion noise model which represents motion noise entering a motion model. Motion noise is an error which occurs when a motional state different from a motional state assumed by a motion model is made. For example, in the case of a motion model in which a uniform linear motion is done, acceleration/deceleration is made, there is an error which occurs in the speed of the observation target, an error which occurs in the speed direction of the observation target when the steering is swung, or the like. The motion noise model wₖ is expressed by Expression (5) or Expression (6) in accordance with a normal distribution of mean 0 and variance Q.

[Equation 4]

p_{w}_{ₖ}(w)=exp{−w^{T}Q⁻¹w} (5)

E(wₖ wₖ^{T})=Q (6)

In the Kalman filter, assuming a probability p (xₖ|z₁, . . . ,zₖ) is a Gaussian distribution, a probability p (xₖ₊₁|z₁, . . . ,zₖ₊₁) at the next time is sequentially calculated. When this happens, the distribution of the state xₖ is expressed by Expression (7) and Expression (8).

[Equation 5]

\hat{x}ₖ⁻=A\hat{x}ₖ₋₁+Buₖ₋₁ (7)

Pₖ⁻=APₖ₋₁A^{T}+Q (8)

ĉₖ⁻: mean value
Pₖ⁻: variance value

The distribution of the state xₖ updated by the observation amount zₖ is expressed by Expression (9) and Expression (10).

[Equation 6]

\hat{x}ₖ=(H^{T}R⁻¹H+(Pₖ⁻)⁻¹)⁻¹(H^{T}R⁻¹zₖ+(Pₖ⁻)⁻¹\hat{x}ₖ⁻⁾ (9)

Pₖ=(H^{T}R⁻¹H +(Pₖ⁻)⁻¹)⁻¹ (10)

Hereinafter, state estimation devices according to first to ninth embodiments will be described in detail. The state estimation devices according to the respective embodiments are represented by reference numerals 11 to 19 in conjunction with the numbers of the embodiments.

### FIRST EMBODIMENT

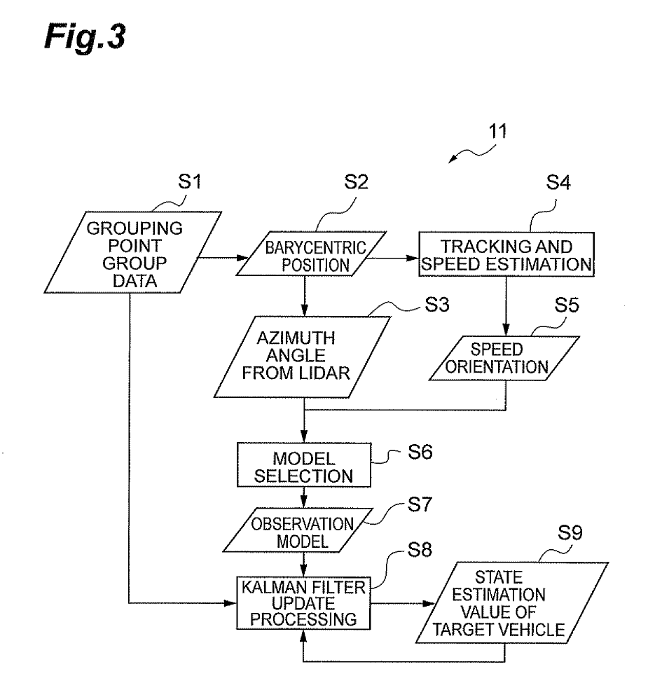

Estimation processing of a state estimation device 11 according to a first embodiment will be described. FIG. 3 is a diagram showing the estimation processing of the state estimation device according to the first embodiment.

As shown in FIG. 3, the state estimation device 11 according to the first embodiment changes an observation model for use in Kalman filter update processing on the basis of the direction of the center position of the target vehicle with respect to the LIDAR 2 and the orientation of the target vehicle. As the observation model, there are eight observation models including a rear observation model intended for the rear surface of the target vehicle, a left oblique rear observation model intended for the rear surface and the left surface of the target vehicle, a left observation model intended for the left surface of the target vehicle, a left oblique front observation model intended for the front surface and the left surface of the target vehicle, a front observation model intended for the front surface of the target vehicle, a right oblique front observation model intended for the front surface and the right surface of the target vehicle, a right observation model intended for the right surface of the target vehicle, and a right oblique rear observation model intended for the rear surface and the right surface of the target vehicle. Accordingly, the state estimation device 11 selects an appropriate observation model from the eight observation models.

First, the state estimation device 11 generates grouping point group data from measured data of the point sequence transmitted from the LIDAR 2 (S1). Specifically, if the LIDAR 2 detects a point sequence of reflection points, the state estimation device 11 groups a point sequence within a predetermined distance to generate grouping point group data. Since grouping point group data is generated corresponding to each vehicle, when a plurality of vehicles are near the host vehicle, a plurality of pieces of grouping point group data are generated.

Next, the state estimation device 11 obtains the barycentric position of grouping point group data generated in S1 (S2). The barycentric position of grouping point group data corresponds to the center position of the target vehicle. For this reason, the barycentric position of grouping point group data can be obtained by, for example, generating a model of a vehicle from grouping point group data and calculating the barycentric position of the model.

The state estimation device 11 calculates the azimuth angle of the barycentric position obtained in S2 when viewed from the LIDAR 2 (S3). That is, the state estimation device 11 calculates the direction of the barycentric position of the target vehicle with respect to LIDAR 2 in S3.

The state estimation device 11 tracks the barycentric position obtained S2 over previous multiple times, and estimates the speed of the barycentric position obtained in S2 (S4). The state estimation device 11 calculates the speed orientation of the barycentric position obtained in S2 by tracking and speed estimation in S4 (S5). That is, the state estimation device 11 calculates the speed orientation of the target vehicle in S5.

Next, the state estimation device 11 selects an observation model from the difference between the azimuth angle of the barycentric position calculated in S3 and the speed orientation of the barycentric position calculated in S5 (S6).

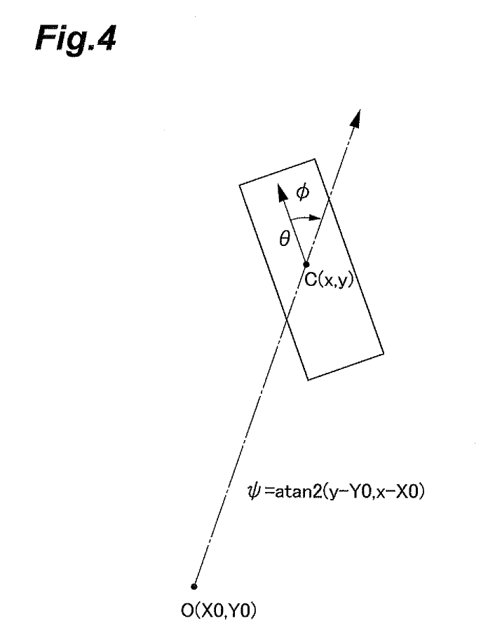

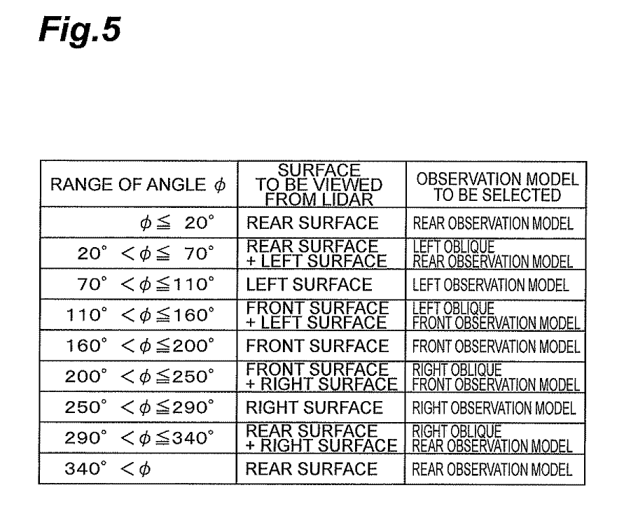

The processing of S6 will be described in detail referring to FIGS. 4 and 5. FIG. 4 is a diagram showing the azimuth angle of the barycentric position and the speed orientation of the barycentric position. FIG. 5 is a diagram showing a change criterion example of an observation model. In FIG. 4, O(X0,Y0) represents the origin of the LIDAR 2, and C(x,y) represents the barycentric position obtained in S2. θ represents the speed orientation of the barycentric position C calculated in the S5, and ψ represents the direction of the barycentric position C with respect to the origin O and the direction calculated in S3.

As shown in FIG. 4, the state estimation device 11 first subtracts the direction w calculated in S3 from the speed orientation θ calculated in S5 to calculate an angle φ. The angle φ is expressed by φ=θ−ψ, and is in a range of 0 to 2π (360°). As shown in FIG. 5, the state estimation device 11 selects an observation model on the basis of the calculated angle φ.

When the angle φ is equal to or smaller than 20°, since only the rear surface of the target vehicle can be viewed from the LIDAR 2, the state estimation device 11 selects the rear observation model.

When the angle φ is greater than 20° and equal to or smaller than 70°, since only the rear surface and the left surface of the target vehicle can be viewed from the LIDAR 2, the state estimation device 11 selects the left oblique rear observation model.

When the angle φ is greater than 70° and equal to or smaller than 110°, since only the left surface of the target vehicle can be viewed from the LIDAR 2, the state estimation device 11 selects the left observation model.

When the angle φ is greater than 110° and equal to or smaller than 160°, since only the front surface and the left surface of the target vehicle can be viewed from the LIDAR 2, the state estimation device 11 selects the left oblique front observation model.

When the angle φ is greater than 160° and equal to or smaller than 200°, since only the front surface of the target vehicle can be viewed from the LIDAR 2, the state estimation device 11 selects the front observation model.

When the angle φ is greater than 200° and equal to or smaller than 250°, since only the front surface and the right surface of the target vehicle can be viewed from the LIDAR 2, the state estimation device 11 selects the right oblique front observation model.

When the angle φ is greater than 250° and equal to or smaller than 290°, since only the right surface of the target vehicle can be viewed from the LIDAR 2, the state estimation device 11 selects the right observation model.

When the angle φ is greater than 290° and equal to or smaller than 340°, since only the rear surface and the right surface of the target vehicle can be viewed from the LIDAR 2, the state estimation device 11 selects the right oblique rear observation model.

When the angle φ is greater than 340°, since only the rear surface of the target vehicle can be viewed from the LIDAR 2, the state estimation device 11 selects the rear observation model.

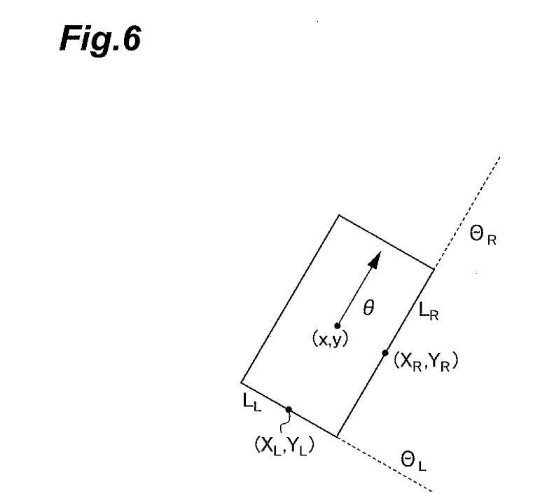

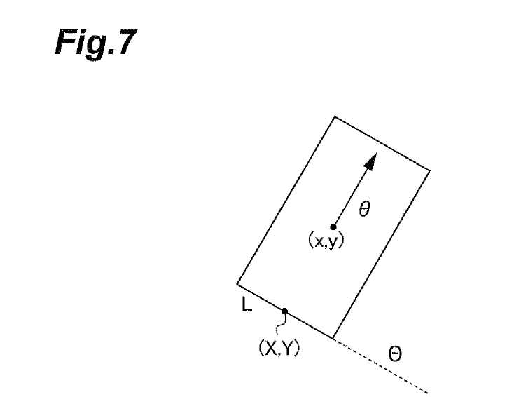

An example of an observation model will be described in detail referring to FIGS. 6 and 7. FIG. 6 is a diagram illustrating a right oblique rear observation model. FIG. 7 is a diagram illustrating a rear observation model.

As shown in FIG. 6, a case where only the rear surface and the right surface of the target vehicle can be viewed from the LIDAR 2 is considered. In this case, if a line is applied to grouping point group data generated in S1, grouping point group data is grouped into right grouping having a point sequence arranged on the right side and left grouping having a point sequence arranged on the left side. Since grouping point group data has a point sequence of reflection points, a line which is applied to grouping point group data corresponds to the front surface, rear surface, right surface, and left surface of the target vehicle.

As described above, the variables to estimate include center position (x), center position (y), speed (v), orientation (θ), tire angle (ζ), wheel base (b), length (l), and width (w) (see FIG. 2). For this reason, variables in the right oblique rear observation model are as follows.
center position (X_{R}) of right grouping
center position (Y_{R}) of right grouping
length (L_{R}) of major axis in right grouping
azimuth (Θ_{R}) of major axis in right grouping
center position (X_{L}) of left grouping
center position (Y_{L}) of left grouping
length (L_{L}) of major axis in left grouping
azimuth (Θ_{L}) of major axis in left grouping

The right oblique rear observation observation model is as follows.
X_{R}=x−1/2×cos(θ)
Y_{R}=y−1/2×sin(θ)
L_{R}=w
Θ_{R}=mod(θ+π/2,π)
X_{L}=x+w/2×sin(θ)
Y_{L}=y−w/2×cos(θ)
L_{L}=1
Θ_{L}=mod(θ,π)

As shown in FIG. 7, a case where only the rear surface of the target vehicle can be viewed from the LIDAR 2 is considered. In this case, if a line is applied to grouping point group data generated in S1, grouping is made into a single group.

As described above, the variables to estimate are center position (x), center position (y), speed (v), orientation (θ), tire angle (ζ), wheel base (b), length (l), and width (w) (see FIG. 2). For this reason, variables in the right oblique rear observation observation model are as follows.
center position (X) of grouping
center position (Y) of grouping
length (L) of major axis in grouping
azimuth (Θ) of major axis in grouping

The right oblique rear observation observation model are as follows.
X=x−1/2×cos(θ)
Y=y−1/2×sin(θ)
L=w
Θ=mod(θ+π/2,π)

The state estimation device 11 decides the observation model selected in S6 as observation model for use in a present estimation (S7).

Next, the state estimation device 11 performs the Kalman filter update processing using grouping point group data generated in S1 and the observation model decided in S7 (S8). At this time, the state estimation device 11 estimates the variables of center position (x), center position (y), speed (v), orientation (θ), tire angle (ζ), wheel base (b), length (l), and width (w), and also calculates a variance (hereinafter, referred to “estimated variance value”) of each estimated variable. The estimated variance value corresponds to a variance value Pₖ which is expressed by Expression (9). The state estimation device 11 outputs the variables calculated by the Kalman filter update processing in S8 as the state estimation values of the target vehicle (S9).

In this way, according to the state estimation device 11 of this embodiment, since the state estimation model is changed on the basis of the positional relationship with the target vehicle or the state of the target vehicle, it is possible to estimate the state of a dynamic target vehicle with higher accuracy.

The observation model is changed on the basis of the difference between the direction of the center position of the target vehicle with respect to the LIDAR 2 and the orientation of the target vehicle, and thus it is possible to appropriately associate measured data with the observation model, thereby further improving estimation accuracy of the state of the target vehicle.

### SECOND EMBODIMENT

Next, estimation processing of a state estimation device 12 according to a second embodiment will be described. The second embodiment is basically the same as the first embodiment except that a method of selecting an observation model is different from the first embodiment. For this reason, only different portions from the first embodiment will be hereinafter described, and description of the same portions as those in the first embodiment will not be repeated.

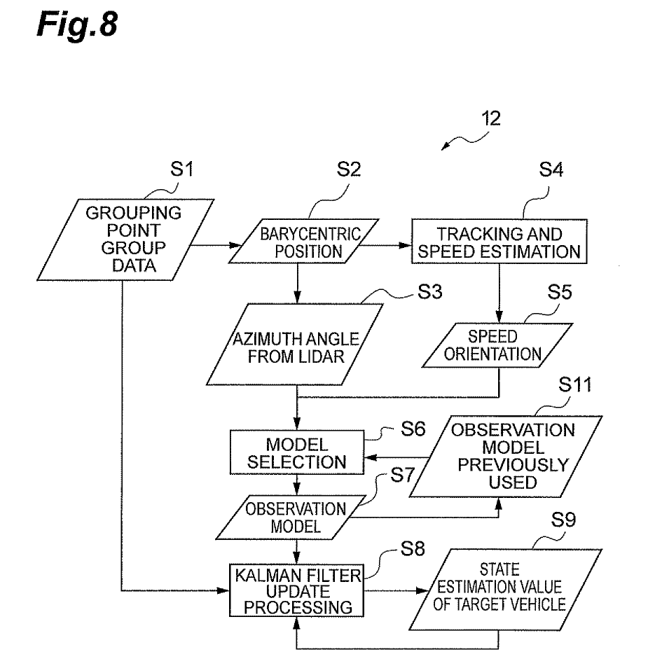

FIG. 8 is a diagram showing estimation processing of the state estimation device according to the second embodiment. As shown in FIG. 8, the state estimation device 12 according to the second embodiment narrows observation models down for use in a present estimation processing on the basis of an observation model used in a previous estimation processing.

Usually, change in the behavior of a vehicle is continuous. For this reason, even if the positional relationship with the target vehicle or the state of the target vehicle is changed over time, the surface of the vehicle which can be viewed from the LIDAR 2 is only changed in order of the rear surface, the left oblique rear surface, the left surface, the left oblique front surface, the front surface, the right oblique front surface, the right surface, and the right oblique rear surface, or in reverse order.

Accordingly, the state estimation device 12 narrows observation models down to be selected in S6 of a present estimation processing on the basis of an observation model decided in S7 of a previous estimation processing (S11).

Specifically, the state estimation device 12 specifies an observation model decided in S7 of the previous estimation processing. The state estimation device 12 also specifies two observation models adjacent to the observation model in the above-described order or in reverse order. The state estimation device 12 narrows an observation model down to be selected in S6 of the present estimation processing to the specified three observation models. For example, when an observation model decided in S7 of the previous estimation processing is a rear observation model, an observation model to be selected in S6 of the present estimation processing is narrowed down to three observation models of a rear observation model, a right oblique rear model, and a left oblique rear model.

In S6, when an observation model to be selected from the difference between the azimuth angle of the barycentric position calculated in S3 and the speed orientation of the barycentric position calculated in S5 is an observation model narrowed down in S11, the state estimation device 12 continues to perform the same processing as in the first embodiment.

In S6, when an observation model to be selected from the difference between the azimuth angle of the barycentric position calculated in S3 and the speed orientation of the barycentric position calculated in S5 is not an observation model narrowed down in S11, the state estimation device 12 determines that a present observation model is likely to be erroneous selected. Then, the state estimation device 12 changes the observation model selected in S6 to the observation model decided in S7 of the previous estimation processing or handles the state estimation value of the observation target output in the present estimation processing as being unreliable.

In this way, according to the state estimation device 12 of the second embodiment, since the observation models for use in the present estimation processing are narrowed down on the basis of the observation model used in the previous estimation processing, it is possible to reduce erroneous selection of an observation model.

### THIRD EMBODIMENT

Next, estimation processing of a state estimation device 13 according to a third embodiment will be described. The third embodiment is basically the same as the first embodiment except that a method of selecting an observation model is different from the first embodiment. For this reason, only different portions from the first embodiment will be hereinafter described, and description of the same portions as those in the first embodiment will not be repeated.

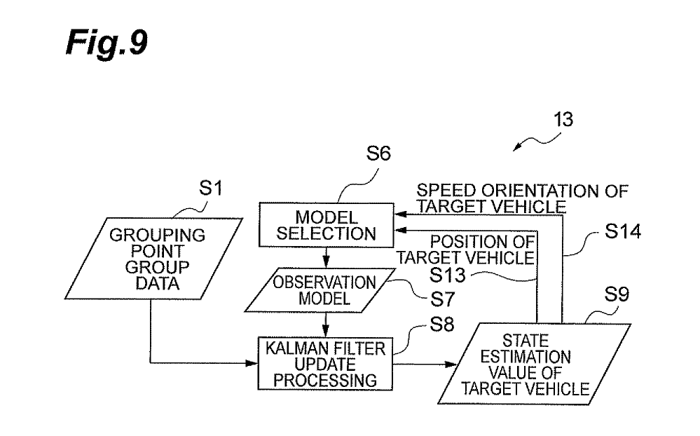

FIG. 9 is a diagram showing estimation processing of a state estimation device according to a third embodiment. As described above, in the first embodiment, the direction of the center position of the target vehicle with respect to the LIDAR 2 and the orientation of the target vehicle are obtained on the basis of grouping point group data generated in S1. In contrast, as shown in FIG. 9, in the third embodiment, The direction of the center position of the target vehicle with respect to the LIDAR 2 and the orientation of the target vehicle are obtained on the basis of a state estimation value of the target vehicle output in a previous estimation processing.

Specifically, the state estimation device 13 extracts the position (x,y) of the target vehicle from a state estimation value of the target vehicle output in S9 of the previous estimation processing, and calculates the direction of the center position of the target vehicle with respect to the LIDAR 2 from the extracted position of the target vehicle (S13). The state estimation device 13 extracts the speed orientation (θ) of the target vehicle from the state estimation value of the target vehicle output in S9 of the previous estimation processing (S14).

The state estimation device 13 selects an observation model from the difference between the direction of the center position of the target vehicle with respect to the LIDAR 2 calculated in S13 and the speed orientation of the target vehicle extracted in S14 (S6).

In this way, according to the state estimation device 13 of the third embodiment, the state estimation value of the target vehicle output in the previous estimation processing is used, and thus continuity of estimation is maintained, thereby further improving estimation accuracy of the state of the target vehicle.

### FOURTH EMBODIMENT

Next, estimation processing of a state estimation device 14 according to a fourth embodiment will be described. The fourth embodiment is basically the same as the first embodiment except that a method of selecting an observation model is different from the first embodiment. For this reason, only different portions from the first embodiment will be hereinafter described, and description of the same portions as those in the first embodiment will not be repeated.

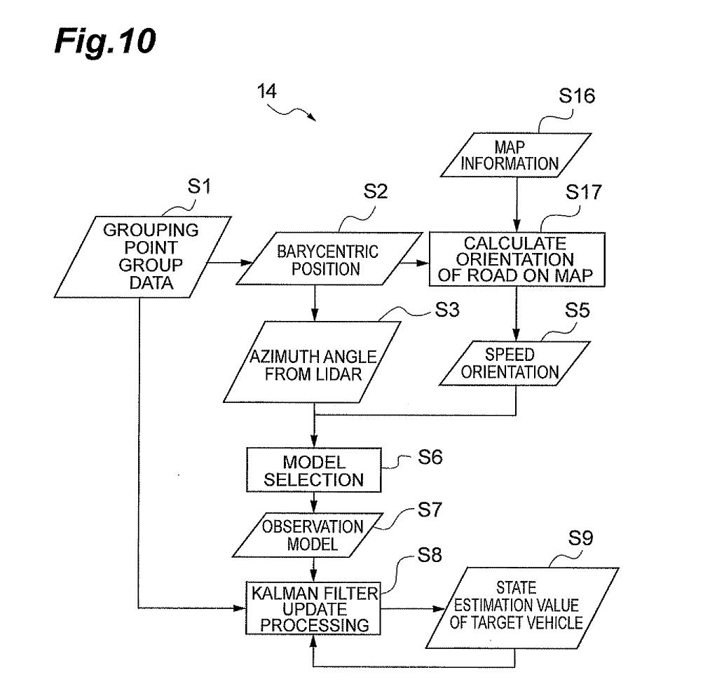

FIG. 10 is a diagram showing estimation processing of a state estimation device according to a fourth embodiment. As described above, in the first embodiment, the orientation of the target vehicle is obtained on the basis of grouping point group data generated in S1. In contrast, as shown in FIG. 10, in the fourth embodiment, the orientation of the target vehicle is obtained on the basis of map information.

Specifically, the state estimation device 14 first acquires map information (S16). For example, the map information may be stored in a storage device mounted in a vehicle, such as a navigation system or may be acquired from the outside of the vehicle by road-to-vehicle communication or the like.

Next, the state estimation device 14 superposes the barycentric position calculated in S2 on the map information acquired in S16 so as to specify the position where the target vehicle is present in the map information. The state estimation device 14 calculates the orientation of a road on the map at the specified position, and estimates the calculated orientation of the road on the map to be the speed orientation of the target vehicle (S17).

In the fourth embodiment, in S2, in addition to calculating the barycentric position of grouping point group data, the position of the target vehicle is estimated from the grouping point group data. In S17, the position where the target vehicle is present on the map may be specified on the basis of the estimated position of the target vehicle.

In this way, according to the state estimation device 14 of the fourth embodiment, the orientation of the target vehicle is estimated on the basis of the position where the target vehicle is present. For this reason, for example, when the target vehicle is stationary, immediately after the target vehicle is detected, or the like, it is possible to estimate the orientation of the target vehicle.

### FIFTH EMBODIMENT

Next, estimation processing of a state estimation device 15 according to a fifth embodiment will be described. The fifth embodiment is basically the same as the first embodiment except that a method of selecting an observation model is different from the first embodiment. For this reason, only different portions from the first embodiment will be hereinafter described, and description of the same portions as those in the first embodiment will not be repeated.

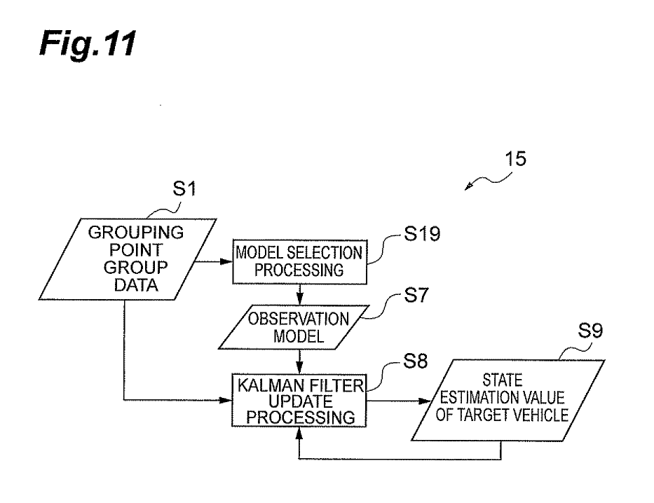

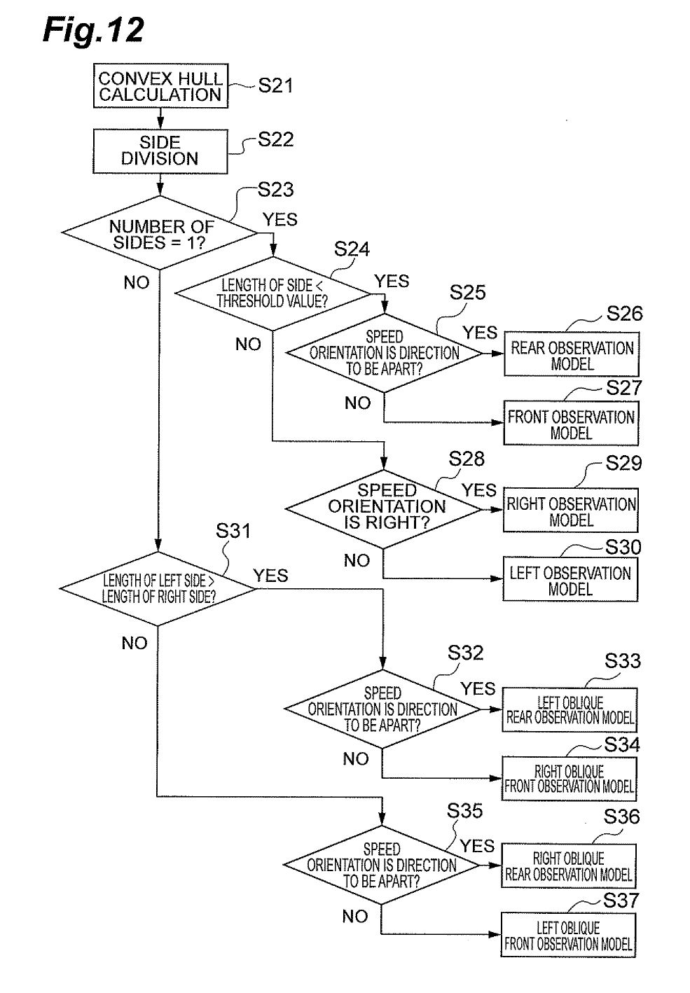

FIG. 11 is a diagram showing estimation processing of the state estimation device according to the fifth embodiment, and FIG. 12 is a diagram showing model selection processing of FIG. 11. As described above, in the first embodiment, an observation model is selected on the basis of the direction of the center position of the target vehicle with respect to the LIDAR 2 and the orientation of the target vehicle calculated from grouping point group data. In contrast, as shown in FIGS. 11 and 12, in the fifth embodiment, an observation model is selected on the basis of the number of sides to be calculated from grouping point group data.

Specifically, as shown in FIG. 10, if grouping point group data is generated in S1, the state estimation device 15 performs model selection processing described below (S19).

The model selection processing of S19 will be described in detail referring to FIG. 11.

The state estimation device 15 first calculates a convex hull of grouping point group data generated in S1 (S21). In the convex hull calculation, first, a right-end point and a left-end point are specified from grouping point group data. The points of grouping point group data are sequentially connected from the right-end (or left) point toward the left side (or the right side), and if the left-end (or right) point is reached, the connection of the points ends. Since the grouping point group data has a point sequence of reflection points, the number of lines connected in the convex hull calculation is one or two corresponding to the lateral surface of the target vehicle.

Next, the state estimation device 15 divides the side of the convex hull calculated in S21 (S22). As described above, since grouping point group data has a point sequence of reflection points, the number of lines connected in the convex hull calculation in S21 is one or two corresponding to the lateral surface of the target vehicle. For this reason, the side of the convex hull is divided in S21, thereby determining which surface of the target vehicle can be viewed from the LIDAR 2.

Next, the state estimation device 15 determines whether or not the number of sides is 1 (S23). If it is determined that the number of sides is 1 (S23: YES), the state estimation device 15 determines whether the length of the side is smaller than a predetermined threshold value (S24). If the number of sides is not 1 (S23: NO), the state estimation device 15 determines whether or not the left side is longer than the right side (S31). The threshold value of S24 is a value for distinguishing between the front and rear surfaces of the vehicle and the left and right surfaces of the vehicle. For this reason, the threshold value of S24 becomes a value between the width of the front and rear surfaces of the vehicle and the length of the left and right surfaces of the vehicle.

In S24, if it is determined that the length of the side is smaller than the predetermined threshold value (S24: YES), the state estimation device 15 determines whether or not the speed orientation of the target vehicle is a direction to be apart with respect to the host vehicle (S25). If it is determined that the length of the side is not smaller than the predetermined threshold value (S24: NO), the state estimation device 15 determines whether or not the speed orientation of the target vehicle is right when viewed from the host vehicle (S28). The speed orientation of the target vehicle can be detected by various methods. For example, as in the first embodiment, the speed orientation of the target vehicle may be obtained by tracking the barycentric position of grouping point group data, or as in the third embodiment, the speed orientation of the target vehicle may be obtained from the state estimation value output in the previous estimation processing.

In S25, if it is determined that speed orientation of the target vehicle is a direction to be apart with respect to the host vehicle (S25: YES), the state estimation device 15 selects the rear observation model (S26). If it is determined that the speed orientation of the target vehicle is not a direction to be apart with respect to the host vehicle (S25: NO), the state estimation device 15 selects the front model (S27).

In S28, if it is determined that the speed orientation of the target vehicle is right when viewed from the host vehicle (S28: YES), the state estimation device 15 selects the right observation model (S29). If it is determined that the speed orientation of the target vehicle is not right when viewed from the host vehicle (S28: NO), the state estimation device 15 selects the left observation model.

In S31, if it is determined that the left side is longer than the right side (S31: YES), the state estimation device 15 determines whether or not the speed orientation of the target vehicle is a direction to be apart with respect to the host vehicle (S32). If it is determined that the left side is not longer than the right side (S31: NO), the state estimation device 15 determines whether or not the speed orientation of the target vehicle is a direction to be apart with respect to the host vehicle (S35).

In S32, if it is determined that the speed orientation of the target vehicle is a direction to be apart with respect to the host vehicle (S32: YES), the state estimation device 15 selects the left oblique rear observation model (S33). If it is determined that the speed orientation of the target vehicle is not a direction to be apart with respect to the host vehicle (S32: NO), the state estimation device 15 selects the right oblique front model (S34).

In S35, if it is determined that the speed orientation of the target vehicle is a direction to be apart with respect to the host vehicle (S35: YES), the state estimation device 15 selects the right oblique rear observation model (S36). If it is determined that the speed orientation of the target vehicle is a direction to be apart with respect to the host vehicle (S35: NO), the state estimation device 15 selects the left oblique rear observation model (S37).

In S35, it may be determined whether or not the speed orientation of the target vehicle is right when viewed from the host vehicle. In this case, if it is determined that the speed orientation of the target vehicle is right when viewed from the host vehicle, the state estimation device 15 may select the right oblique rear observation model (S36). If it is determined that the speed orientation of the target vehicle is not right when viewed from the host vehicle, the state estimation device 15 may determine the left oblique rear observation model (S37).

If the observation model is selected in the above-described manner, as shown in FIG. 10, the state estimation device 15 decides the observation model selected in S19 as an observation model for use in the present estimation (S7).

In this way, according to the state estimation device 15 of the fifth embodiment, the observation model is changed on the basis of the number of sides obtained from grouping point group data, and thus the selection criterion of the observation model is clarified, thereby further improving estimation accuracy of the state of the target vehicle.

### SIXTH EMBODIMENT

Next, estimation processing of a state estimation device 16 according to a sixth embodiment will be described. The sixth embodiment is basically the same as the first embodiment except that only an observation noise model of an observation model is changed unlike the first embodiment. For this reason, only different portions from the first embodiment will be hereinafter described, and description of the same portions as those in the first embodiment will not be repeated.

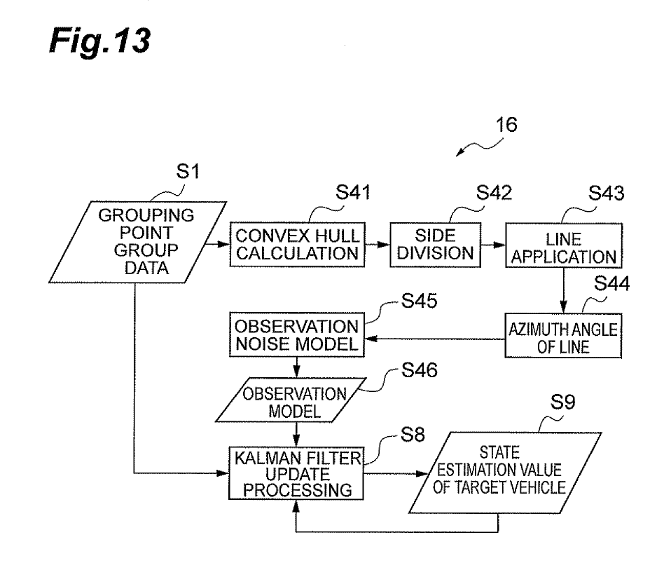

FIG. 13 is a diagram showing estimation processing of a state estimation device according to a sixth embodiment. As described above, in the first embodiment, an observation model is selected on the basis of the direction of the center position of the target vehicle with respect to the LIDAR 2 and the orientation of the target vehicle calculated from grouping point group data. In contrast, as shown in FIG. 13, in the sixth embodiment, an observation noise model is changed on the basis of the azimuth angle of a side to be calculated from grouping point group data.

Here, the relationship between an orientation with respect to the surface of the target vehicle and an observation error will be described.

In general, since the LIDAR 2 has resolution of about 10 cm, a measurement error of a point sequence p is small. Meanwhile, since the LIDAR 2 has a characteristic in that a point sequence is not easily detected from an end portion, the center of a point sequence detected by the LIDAR 2 is at a position shifted from the center of the surface of the target vehicle. For this reason, while observation noise in a direction perpendicular to the surface of a target vehicle 3 is small, observation noise in a direction parallel to the surface of the target vehicle 3 is greater than observation noise in the direction perpendicular to the surface of the target vehicle 3.

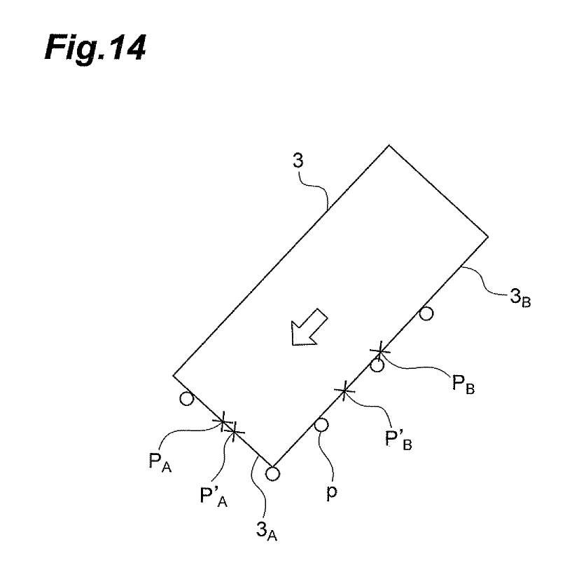

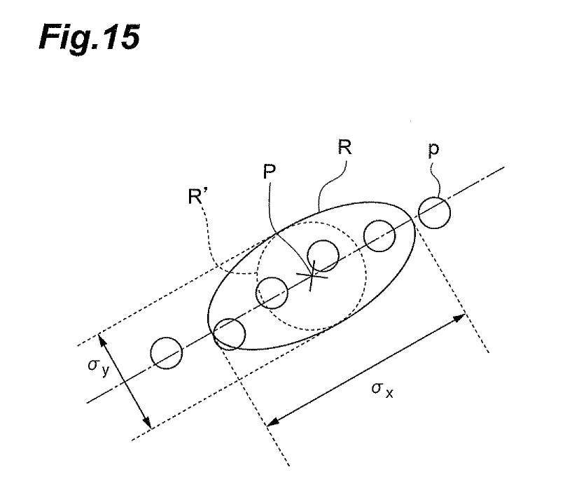

FIG. 14 is a diagram showing the relationship between a target vehicle and grouping point group data, and FIG. 15 is a diagram showing the concept of an observation noise model. An arrow of FIG. 14 represents the traveling direction of the target vehicle.

As shown in FIG. 14, a case where a front surface 3_{A} and a left surface 3_{B} of the target vehicle 3 can be viewed from the LIDAR 2, and a point sequence p of reflection points of laser light emitted from the LIDAR 2 is detected in the front surface 3_{A} and the left surface 3_{B} of the target vehicle 3 is considered.

In this case, no point sequence p is detected from the right potion (in FIG. 14, an upper left portion) of the front surface 3_{A} and the rear portion (in FIG. 14, an upper right portion) of the left surface 3_{B}. For this reason, the center P_{A}′ of the point sequence p in the front surface 3_{A} is shifted to the left side (in FIG. 14, a lower right side) of the front surface 3_{A} from the center P_{A} of the front surface 3_{A}. The center P_{B}′ of the point sequence p in the left surface 3_{B} is shifted to the front side (in FIG. 14, a lower left side) of the left surface 3_{B} from the center P_{B} of the left surface 3_{B}.

As described above, the center position (x,y) is a variable of an observation model. For this reason, if the center position of the front surface 3_{A} is calculated on the basis of the point sequence p detected by the LIDAR 2, observation noise in the direction parallel to the front surface 3_{A} of the target vehicle 3 becomes greater than observation noise in the direction perpendicular to the front surface 3_{A}. If the center position of the left surface 3_{B} is calculated on the basis of the point sequence p detected by the LIDAR 2, observation noise in the direction parallel to the left surface 3_{B} of the target vehicle 3 becomes greater than observation noise in the direction perpendicular to the left surface 3_{B}.

Accordingly, as shown in FIG. 15, although a variance value R′ of a center position in an observation noise model is usually represented by a perfect circle, in the sixth embodiment, the variance value R of the center position in the observation noise model is changed such that observation noise in the direction parallel to the surface of the target vehicle becomes greater than observation noise in the direction perpendicular to the surface of the target vehicle.

Specifically, if an error in the direction perpendicular to the surface of the target vehicle is σ_{y}, an error in the direction parallel to the surface of the target vehicle is σₓ, and a rotating matrix is R_{θ}, the variance value R of the center position in the observation noise model is expressed by Expression (11). A calculation method of Expression (11) is described in Expression (12).

$$\begin{matrix}[ Equation 7 ] & \\ R = {R}_{θ} [ \begin{matrix}{σ}_{x}^{2} & 0 \\ 0 & {σ}_{y}^{2}\end{matrix} ] {R}_{θ}^{T} & ( 11 ) \\ [ Equation 8 ] & \\ R = E [ ( \begin{matrix}x \\ y\end{matrix} ) ( xy ) ] \\ If ( \begin{matrix}x \\ y\end{matrix} ) = {R}_{θ} ( \begin{matrix}X \\ Y\end{matrix} ) , \\ \begin{matrix}R = E [ {R}_{θ} ( \begin{matrix}X \\ Y\end{matrix} ) ( XY ) {R}_{θ}^{T} ] \\ = {R}_{θ} E [ ( \begin{matrix}X \\ Y\end{matrix} ) ( XY ) ] {R}_{θ}^{T} \\ = {R}_{θ} {R}_{0} {R}_{θ}^{T}\end{matrix} \\ {R}_{0} = E [ ( \begin{matrix}X \\ Y\end{matrix} ) ( XY ) ] = [ \begin{matrix}{σ}_{x}^{2} & 0 \\ 0 & {σ}_{y}^{2}\end{matrix} ] & ( 12 )\end{matrix}$$

Next, the processing of the state estimation device 16 will be described referring to FIG. 13.

The state estimation device 16 calculates the convex hull of grouping point group data generated in S1 (S41), and divides the side of the calculated convex hull (S42). The convex hull calculation in S41 is the same as the convex hull calculation (see FIG. 12) in S21 which is performed by the state estimation device 16 according to the fifth embodiment.

Next, the state estimation device 16 applies the side divided in S42 to one or two lines (S43), and calculates the azimuth angle of the applied line (S44).

As expressed by Expression (11), the state estimation device 16 changes the variance value R of the center position in the observation noise model on the basis of the azimuth angle of the line calculated in S44 (S45).

The state estimation device 16 decides an observation model having an observation noise model with the variance value changed in S45 incorporated therein as an observation model for use in the present estimation (S46).

In this way, according to the state estimation device 16 of the sixth embodiment, since the variance value of the observation noise model is changed on the basis of the orientation with respect to the surface of the target vehicle, it is possible to further improve estimation accuracy of the state of the target vehicle.

### SEVENTH EMBODIMENT

Next, estimation processing of a state estimation device 17 according to a seventh embodiment will be described. The seventh embodiment is basically the same as the first embodiment except that only an observation noise model of an observation model is changed unlike the first embodiment. For this reason, only different portions from the first embodiment will be hereinafter described, and description of the same portions as those in the first embodiment will not be repeated.

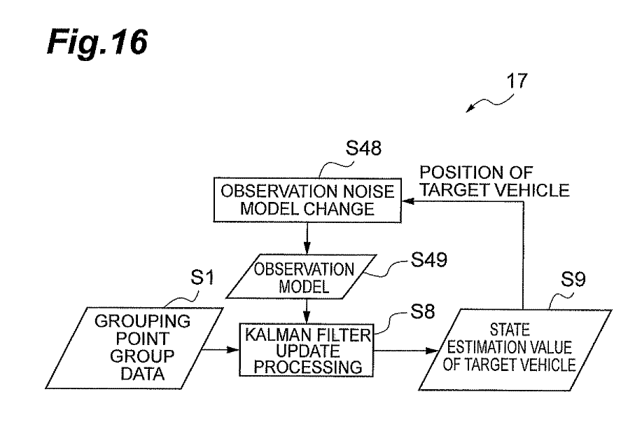

FIG. 16 is a diagram showing estimation processing of a state estimation device according to a seventh embodiment. As described above, in the first embodiment, an observation model is selected on the basis of the direction of the center position of the target vehicle with respect to the LIDAR 2 and the orientation of the target vehicle calculated from grouping point group data. In contrast, as shown in FIG. 16, in the seventh embodiment, an observation noise model is changed on the basis of the distance to the target vehicle.

The state estimation device 17 first extracts the position of the target vehicle from the state estimation value of the target vehicle output in S9 of the previous estimation processing. At this time, as in the first embodiment, the state estimation device 17 may use the barycentric position to be calculated from grouping point group data generated in S1 of the present estimation processing instead of the state estimation value output in S9 of the previous estimation processing. Next, the state estimation device 17 calculates the distance from the host vehicle to the target vehicle from the extracted position of the target vehicle. The state estimation device 17 changes observation noise in the observation noise model on the basis of the calculated distance from the host vehicle to the target vehicle (S48).

Specifically, if the host vehicle is close to the target vehicle, since the region to be measured of the target vehicle by the LIDAR 2 increases, observation noise decreases. If the host vehicle is far from the target vehicle, since the region to be measured of the target vehicle by the LIDAR 2 decreases, observation noise increases. Accordingly, as the host vehicle is farther from the target vehicle, the state estimation device 17 increases observation noise in the observation noise model. For example, observation noise in the observation noise model may be changed continuously depending on the distance from the host vehicle to the target vehicle or may be changed in a single step or a plurality of steps depending on the distance from the host vehicle to the target vehicle. In the latter case, for example, a single distance or a plurality of distances may be set, and each time the distance from the host vehicle to the target vehicle exceeds the set distance, observation noise in the observation noise model may be increased. As observation noise to be changed, various kinds of noise, such as the center position of the surface of the target vehicle, the speed of the target vehicle, and the orientation of the target vehicle, may be used.

The state estimation device 17 decides an observation model having the observation noise model changed in S48 incorporated therein as an observation model for used in the present estimation (S49).

In this way, according to the state estimation device 17 of the seventh embodiment, observation noise in the observation noise model is changed on the basis of the distance to the target vehicle, thereby further improving estimation accuracy of the state of the target vehicle.

### EIGHTH EMBODIMENT

Next, estimation processing of a state estimation device 18 according to an eighth embodiment will be described. The eighth embodiment is basically the same as the first embodiment except that only a motion noise model is changed unlike the first embodiment. For this reason, only different portions from the first embodiment will be hereinafter described, and description of the same portions as those in the first embodiment will not be repeated.

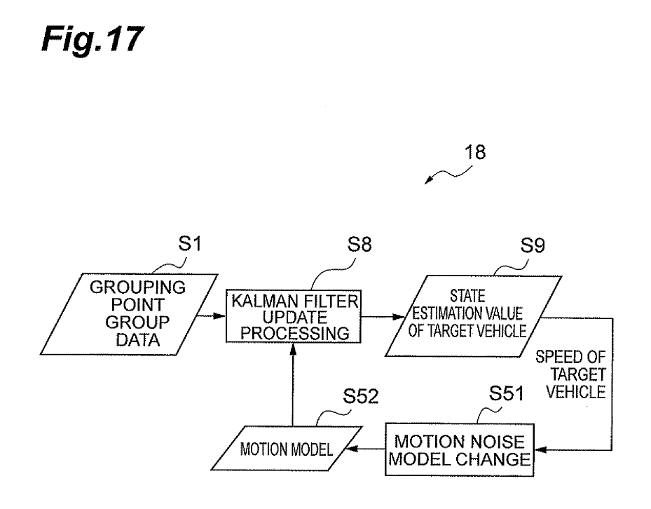

FIG. 17 is a diagram showing estimation processing of a state estimation device according to an eighth embodiment. As described above, in the first embodiment, an observation model is changed on the basis of the direction of the center position of the target vehicle with respect to the LIDAR 2 and the orientation of the target vehicle. In contrast, as shown in FIG. 17, in the eighth embodiment, a motion noise model of a motion model is changed on the basis of the speed of the target vehicle.

Here, a motion noise model will be described in detail. As described above, the variables to estimate are center position (x), center position (y), speed (v), orientation (θ), tire angle (ζ), wheel base (b), length (l), and width (w) (see FIG. 2). For this reason, a motion model is represented as follows.
x:=x+v×cos(θ)
y:=y+v×sin(θ)
v:=v
θ:=θ+v/b×tan(ζ)
b:=b
l:=1
w:=w

When a motion model is a uniform linear motion, for example, a motion noise model entering the motion model is as follows.
σ(x)=0
σ(y)=0
σ(v)=acceleration/deceleration
σ(θ)=0
σ(ζ)=steering change amount (amount of change in steering angle)
σ(b)=0
σ(l)=0
σ(w)=0

In this way, the steering change amount and the acceleration/deceleration are set in a motion noise model entering a motion model, in the related art, these values are set to have fixed values in the motion noise model. However, as the speed of the vehicle increases, there is a tendency that the steering is unlikely to be swung largely.

Accordingly, the state estimation device 18 first extracts the speed of the target vehicle from the state estimation value of the target vehicle output in S9 of the previous estimation processing. The state estimation device 18 changes the steering change amount σ(ζ) in the motion noise model on the basis of the extracted speed of the target vehicle (S51). Specifically, as the speed of the target vehicle is higher, the state estimation device 18 decreases the steering change amount σ(ζ) in the motion noise model. For example, the steering change amount σ(ζ) may be changed continuously depending on the speed of the target vehicle or may be changed in a single step or a plurality of steps depending on the speed of the target vehicle. In the latter case, for example, a single speed or a plurality of speeds may be set, and each time the speed of the target vehicle exceeds the set speed, the steering change amount σ(ζ) may be decreased.

The state estimation device 18 decides the motion model having the motion noise model changed in S51 incorporated therein as a motion model for use in the present estimation (S52).

In this way, according to the state estimation device 18 of the eighth embodiment, if the speed of the target vehicle is high, the steering change amount σ(ζ) in the motion noise model is decreased, thereby further improving estimation accuracy of the state of the target vehicle.

### NINTH EMBODIMENT

Next, estimation processing of a state estimation device 19 according to a ninth embodiment will be described. In the first embodiment, an observation noise model for use in the estimation processing is changed so as to estimate the state of the target vehicle. In contrast, in the ninth embodiment, the state of the target vehicle is estimated using a plurality of different observation models, and the state of the observation target estimated using an observation model having the smallest estimated variance value is output.

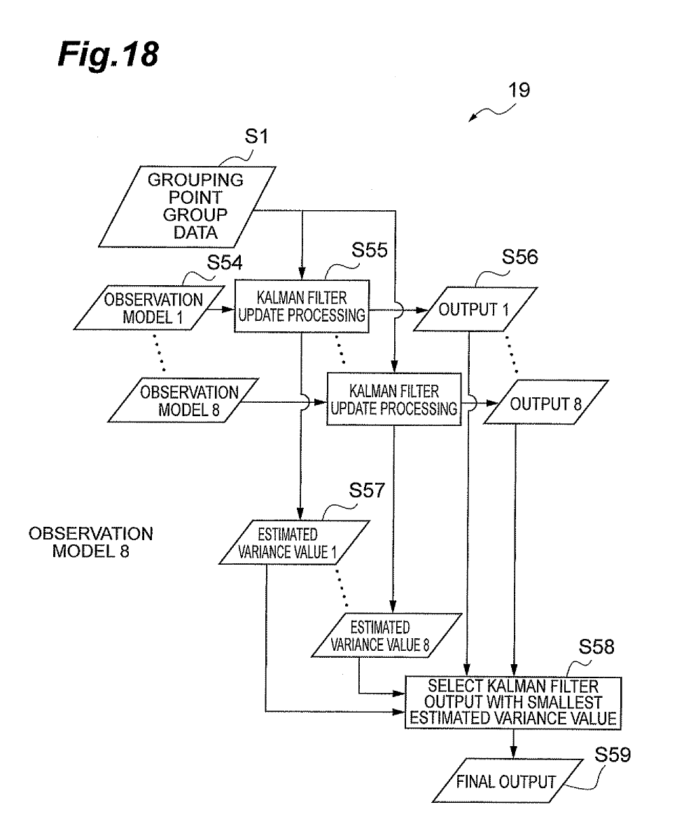

FIG. 18 is a diagram showing estimation processing of a state estimation device according to a ninth embodiment. As shown in FIG. 18, the state estimation device 19 prepares a plurality of different observation models (S54). The observation models to be prepared in S54 are eight observation models of a rear observation model, a left oblique rear observation model, a left observation model, a left oblique front observation model, a front observation model, a right oblique front observation model, a right observation model, and a right oblique rear observation model. Although in the following description, a case where the number of observation models to be prepared in S54 is eight will be described, the number of observation models is not particularly limited insofar as at least two observation models are prepared.

Next, the state estimation device 19 applies grouping point group data generated in S1 to the eight observation models prepared in S54, and performs Kalman filter update processing in parallel (S55). The Kalman filter update processing of S55 is the same as the Kalman filter update processing of S8 in the first embodiment.

The state estimation device 19 outputs the respective variables of center position (x), center position (y), speed (v), orientation (θ), tire angle (ζ) wheel base (b), length (l), and width (w) estimated in the respective Kalman filter update processing of S55 (S56).

The state estimation device 19 calculates the estimated variance values of the respective variables calculated in the respective Kalman filter update processing of S55 (S57).

The state estimation device 19 sets a Kalman filter output having the smallest estimated variance value from among the eight Kalman filter outputs output in S56 as a final output (S59).

In this way, according to the state estimation device 19 of the ninth embodiment, even when the positional relationship with the target vehicle or the state of the target vehicle is not clear, it is possible to output the state estimation value of the target vehicle estimated using an appropriate observation model.

Although the preferred embodiments of the invention have been described, it should be noted that the invention is not limited to the foregoing embodiments.

For example, in the foregoing embodiments, a case where the Kalman filter is introduced as the estimation means for estimating the state of the target vehicle has been described. However, any means or any filters may be introduced insofar as measured data is applied to a model so as to estimate the state of the target vehicle. For example, a particle filter may be introduced.

Although in the foregoing embodiment, a near vehicle near the host vehicle is introduced as an observation target, everything, such as a motorcycle or a bicycle, may be introduced as an observation target.

Although in the first embodiment, a case where an observation model is changed on the basis of the direction of the center position of the target vehicle with respect to the LIDAR 2 and the orientation of the target vehicle has been described, an observation model may be changed on the basis of only the direction of the center position of the target vehicle with respect to the LIDAR 2 or an observation model may be changed on the basis of only the orientation of the target vehicle.

Even if the direction of the center position of the target vehicle with respect to the LIDAR 2 differs, the measurable surface of the target vehicle differs, and even if the orientation of the target vehicle differs, the measurable surface of the target vehicle differs. For this reason, even if an observation model is changed on the basis of either the direction of the center position of the target vehicle with respect to the LIDAR 2 or the orientation of the target vehicle, it is possible to appropriately associate measured data with an observation model. Therefore, it is possible to further improve estimation accuracy of the state of the target vehicle.

The foregoing embodiments may be appropriately combined. For example, the first embodiment and the sixth embodiment may be combined such that an observation model and an observation noise model are changed, and the first embodiment and the eighth embodiment may be combined such that an observation model and a motion model may be changed.

### INDUSTRIAL APPLICABILITY

The invention can be used as a state estimation device which estimates the state of a near vehicle.

### REFERENCE SIGNS LIST

1 (11 to 19): state estimation device, 2: LIDAR (measurement device), 3: target vehicle.

1-12. (canceled)

13. A state estimation device which applies measured data measured by a measurement device measuring an observation target to a state estimation model so as to estimate the state of the observation target,
wherein the state estimation model includes an observation model representing one surface or two surfaces of the observation target to be measured by the measurement device, and
the state estimation device comprises:
changing means for changing the observation model on the basis of the positional relationship with the observation target.

14. The state estimation device according to claim 13,
wherein the observation target is a vehicle near the measurement device, and
the changing means changes the observation model to an observation model corresponding to the direction of the center position of the observation target with respect to the measurement device.

15. The state estimation device according to claim 13,
wherein the observation target is a vehicle near the measurement device, and
the changing means changes the observation model to an observation model corresponding to the orientation of the observation target.

16. The state estimation device according to claim 13,
wherein the observation target is a vehicle near the measurement device, and
the changing means changes the observation model to an observation model corresponding to both the direction of the center position of the observation target with respect to the measurement device and the orientation of the observation target.

17. The state estimation device according to claim 13,
wherein the changing means narrows observation models down, to which measured data is applied, on the basis of an observation model used in previous estimation.

18. The state estimation device according to claim 14,
wherein the changing means estimates the direction of the center position of the observation target with respect to the measurement device or the orientation of the observation target on the basis of the previously estimated state of the observation target.

19. The state estimation device according to claim 15,
wherein the changing means estimates the orientation of the observation target on the basis of map information of a position where the observation target is present.

20. The state estimation device according to claim 13,
wherein the changing means generates a model of the observation target from measured data and changes the observation model on the basis of the number of sides constituting the model.

21. The state estimation device according to claim 13,
wherein the state estimation model includes an observation noise model which represents observation noise due to a measurement of the measurement device as a variance value, and
the changing means changes the variance value of the observation noise model on the basis of the orientation with respect to the surface of the observation target.

22. The state estimation device according to claim 21,
wherein the changing means changes the observation noise model on the basis of the distance to the observation target.

23. The state estimation device according to claim 13,
wherein the observation target is a vehicle near the measurement device,
the state estimation model includes a motion model which represents the motional state of the near vehicle, and a motion noise model which represents the amount of change in a steering angle in the motion model, and
if the speed of the observation target is high, the changing means decreases the amount of change in the steering angle in the motion noise model compared to when the speed of the observation target is low.

24. The state estimation device according to claim 13,
wherein the state of the observation target is estimated using a plurality of different observation models, estimated variance values of the state of the observation target are calculated, and the state of the observation target with the smallest estimated variance value is output.
